(19) United States
(12) Patent Application Publication
(10) Pub. No.: US 2022/0048587 A1
(43) Pub. Date: Feb. 17, 2022

(54) FOLDABLE SCOOTER

(71) Applicant: Zhongshan Zexiston Daily Necessities Co., Ltd, Zhongshan City (CN)

(72) Inventor: Haiyang ZHANG, Zhongshan City (CN)

(21) Appl. No.: 16/994,301

(22) Filed: Aug. 14, 2020

(51) Int. Cl. B62K 3/00; B62K 15/00

(52) U.S. Cl. CPC B62K 3/002; B62K 15/006

(57) ABSTRACT

A foldable scooter comprises a front wheel unit, a frame unit, a rear wheel unit, and a. seat unit. The frame unit comprises a connecting rod, a linking rod, and a stand, wherein the stand comprises a footboard, a chassis, and two side cover plates located on two sides of the footboard, the linking rod is located in a space between the footboard and the chassis, the connecting rod has an end fixedly connected with the front wheel unit and an end stretching into the middle of the footboard from front to be fixedly connected with the front end of the linking rod, and the rear end of the linking rod is fixedly connected with the rear wheel unit. The foldable scooter is simple in structure, convenient to operate, and capable of being folded to he stored and transported easily.

### BACKGROUND OF THE INVENTION

### Technical Field

The invention relates to the field of scooters, in particular to a foldable scooter.

### Description of Related Art

As common vehicles, scooters are nowadays usually used by people who have difficulties in walking to bring convenience to people. The scooters can assist those who have problems walking and the aged who cannot walk stably in improving the moving capacity and independence, thereby bringing convenience to users as well as other people. In addition, the scooters are also used by patients who have difficulties in walking temporarily before operation or in the recovery period so as to facilitate independent activities in ordinary life.

Traditional scooters or similar vehicles with the same function cannot be folded. Up to now, foldable scooters have been developed after long-term practical usage to meet practical requirements. For instance, Chinese Utility Model Patent Application No.CN201620250768.9 and Chinese Utility Model Patent Application No.CN201620251559.6 disclose foldable scooters; however, such foldable scooters are large in size, complex in structure, and difficult to operate and cannot be easily operated by the aged or the wounded, which in turn causes inconvenience in use; and in addition, the complex structural design increases production costs of manufacturers and causes more faults, which in turns increases the maintenance frequency and costs and prolongs the maintenance time.

Therefore, it has become a problem urgently to be solved by those skilled in the field to develop a foldable scooter which is simple in design structure and easy to operate.

### BRIEF SUMMARY OF THE INVENTION

The technical issue to be settled by the invention is to overcome the defects of the prior art by providing a foldable scooter so as to solve the problem that traditional foldable scooters are too complex in structural design, prone to breaking down and inconvenient to operate.

The technical solution adopted by the invention to settle the above technical issue is as follows: a foldable scooter comprises a front wheel unit, a frame unit, a rear wheel unit, and a seat unit, wherein the frame unit comprises a connecting rod, a linking rod, and a stand; the stand comprises a footboard, a chassis, and two side cover plates located on two sides of the footboard; the linking rod is located in a space between the footboard and the chassis; the connecting rod has an end fixedly connected with the front wheel unit and an end stretching into the middle of the footboard from front to be fixedly connected with the front end of the linking rod; the rear end of the linking rod is fixedly connected with the rear wheel unit; and the seat unit is located above the rear wheel unit and is connected with the rear portion of the stand.

Preferably, the front wheel unit comprises a handlebar, a vertical handlebar tube, a front tube, an upright tube, a front fork, and a front wheel, wherein the vertical handlebar tube has an end vertically connected with the handlebar and an end sleeved with the front tube, the front tube has an end connected with the upright tube, the upright tube is connected with the front fork through a head set, and the front wheel is fixed to the front fork.

Preferably, the rear wheel unit comprises a pair of rotary shafts, a pair of swing arms, a pair of tie rods, and a pair of rear wheels, wherein the rotary shafts are fixedly connected into the space between the footboard and the chassis and are connected with the front ends of the swing arms, the tail ends of the swing arms are fixedly connected with the rear wheels and are pivoted to the tie rods, and each tie rod has an end pivoted and fixed to the linking rod.

Preferably, the seat unit comprises a cushion, a cushion base, and a cushion fixing rod, wherein the cushion base is arranged under the cushion, the cushion fixing rod has an upper end pivoted to the cushion base and a tail end formed with a curved bent part, the bent part stretches into the stand to be pivoted to the tail end of the linking rod, and a pivot part is connected to the bent part and is connected with the stand.

Preferably, auxiliary wheels are arranged under two sides of the front end of the stand.

Preferably, the auxiliary wheels are slightly above the ground.

Preferably, a slot is formed in the rear end of the footboard, positioning plates are arranged on two sides of the slot and are provided positioning holes, and the cushion connecting rod is pivoted and connected to the positioning plates.

Preferably, a seat back is arranged behind the cushion and is provided with a handle.

Preferably, the cushion fixing rod is provided with a limiting plate located in the curved part, and the limiting part is provided with a first limiting hole and a second limiting hole.

Preferably, a protective plate is correspondingly arranged at the position, where the connecting rod stretches, of the footboard, and the connecting rod is pivoted to the protective plate.

Compared with the prior art, the invention has the following beneficial effects: the linking rod is pivoted to the connecting rod, and the cushion fixing rod stretches into the slot of the stand to be pivoted to the tail end of the linking rod, so that when the handlebar is pressed downwards, the front wheel is driven to tilt away from the ground, and the connecting rod pulls the linking rod which in turn drives the cushion fixing rod to swing backwards to drive the cushion to descend; at this moment, the linking rod synchronous pulls the tie rods to drag the swing arms to retreat backwards with the axle as the fulcrum, so that the swing arms, the rear wheels and the tie rods are folded behind the stand, and the swing arms and the tie rods are mostly drawn into the space between the footboard and the chassis of the stand. In this way, the size of the scooter is minimized, and the scooter can be stored and transported easily.

### BRIEF DESCRIPTION OF THE SEVERAL VIEWS OF THE DRAWINGS

The invention is further described below in combination with accompanying drawings and embodiments.

FIG. 1 is a schematic diagram of a foldable scooter of the invention.

FIG. 2. is an exploded view of the foldable scooter.

FIG. 3 is a partial exploded view of the foldable scooter.

FIG. 4 is another partial exploded view of the foldable scooter.

FIG. 5 is a side view of the foldable scooter in the folding process.

FIG. 6 is a top view of the foldable scooter in the folding process.

FIG. 7 is a side view of the foldable scooter in a folded state.

FIG. 8 is a top view of the foldable scooter in the folded state.

FIG. 9 is a schematic diagram of Embodiment 1,

1, front wheel unit; 11, handlebar; 12, vertical handlebar tube; 13, front tube; 14, upright tube; 15, head set; 16, front fork; 17, front wheel; 2, frame unit; 21, linking rod; 22, connecting rod; 23, stand; 231, footboard; 232, side cover plate; 233, chassis; 234, protective plate; 235, slot; 236, positioning plate; 237, positioning hole; 24, auxiliaty wheel; 3, rear wheel unit; 31, rotary shaft; 32, swing arm; 33, rear wheel; 331, axle; 34, tie rod; 4, seat unit; 41, cushion; 42, handle; 43, cushion base; 44, cushion fixing rod; 441, bent part; 442, pivot part; 443, limiting plate; 444, first limiting hole; 445, second limiting hole; 45, cushion connecting rod; 5, pin.

### DETAILED DESCRIPTION OF THE INVENTION

The invention is further expounded below with reference to the accompanying drawings. These drawings are simplified ones used to illustratively explain the basic structure of the invention and only show components involved in the invention.

What should be pointed out is that directional or positional relations indicated by the terms such as “upper”, “lower”, “inner” and “outer” in the invention refer to directional or positional relations shown in the drawings, are only used for providing a better and brief description of the invention, and do not indicate or imply that the devices or elements referred to shall have specific directions or shall be configured or operated in specific directions, and thus, these terms should not be regarded as limitations of the invention; the terms “first” and “second” are only used for the purpose of description, and do not indicate or imply relative importance; in addition, unless otherwise clearly specified or limited, the terms “mount”, “connect” and “connection” should be extensively understood, for instance, “connection” may refer to “fixed connection”, “detachable connection”, “integral connection”, “mechanical connection”, “electrical connection”, “direct connection”, “indirect connection via an intermediate medium”, or “internal connection of two elements”. Those ordinarily skilled in the field should appreciate the specific meanings of these terms in the invention as the case may be,

### Embodiment 1

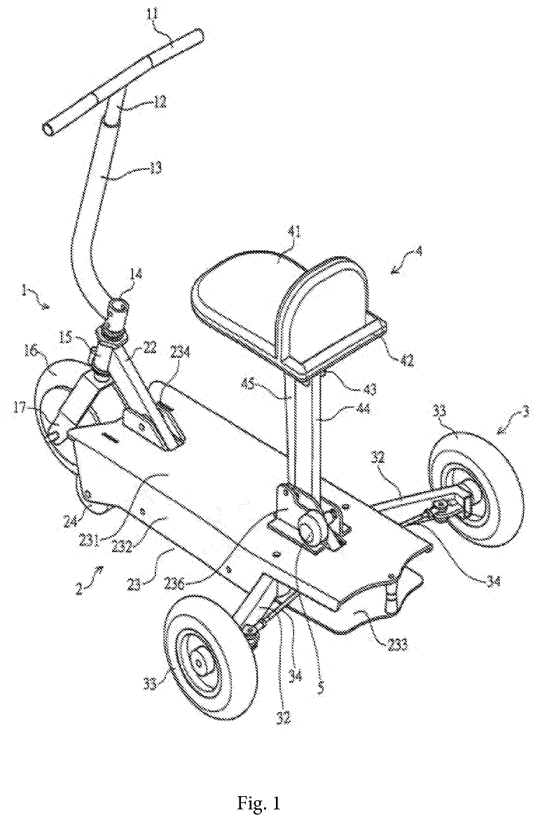

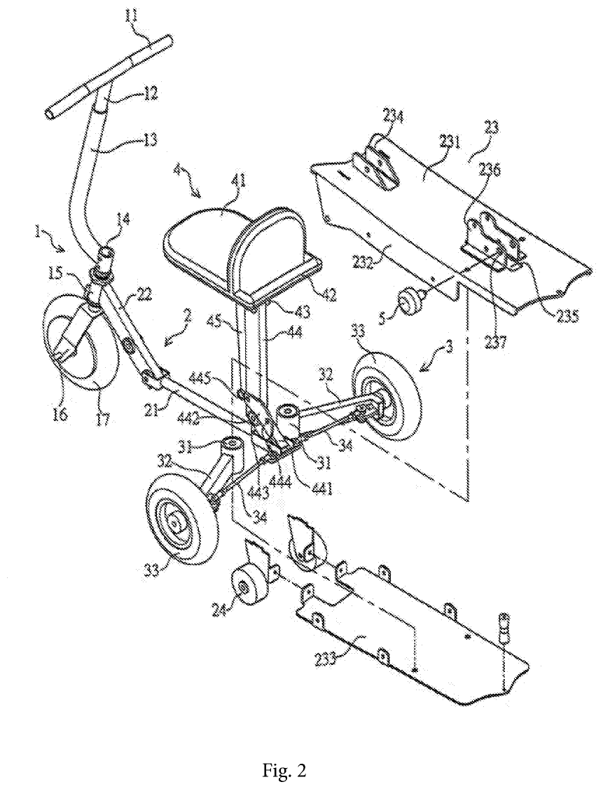

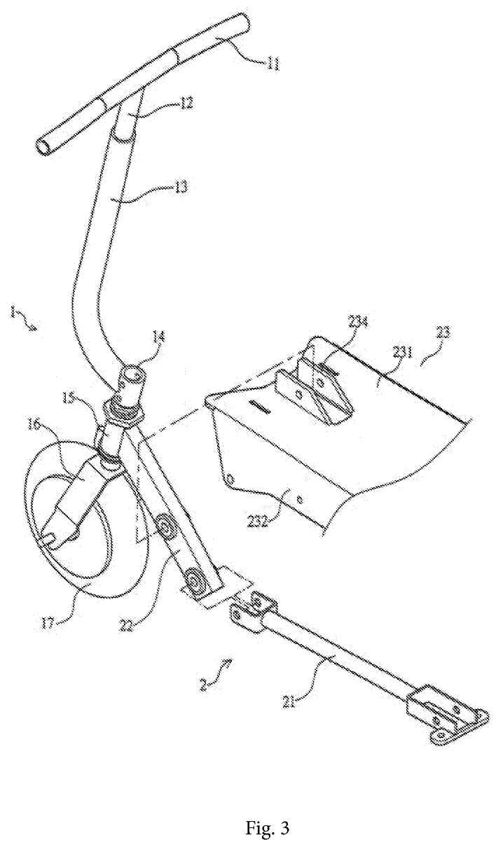

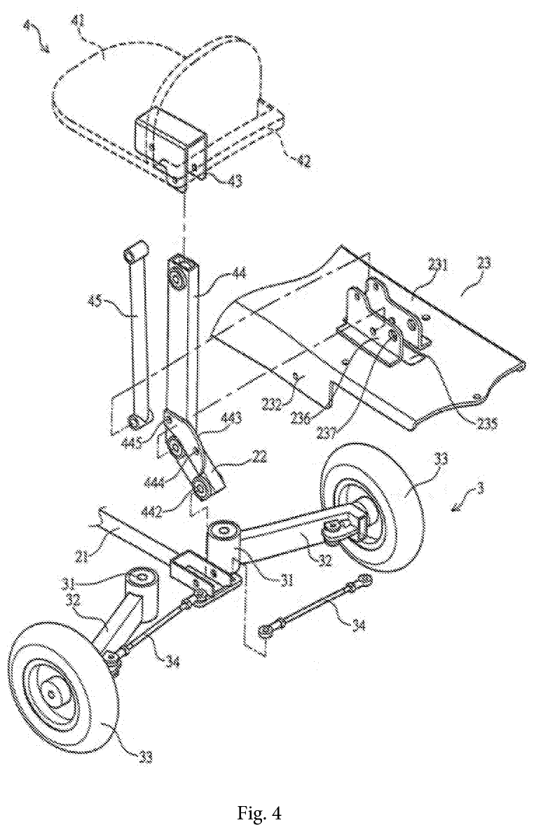

Referring to FIG. 1-FIG. 4, a foldable scooter comprises a front wheel unit 1, a frame unit 2, a rear wheel unit 3, and a seat unit 4, wherein:

The front wheel unit 1 comprises a handlebar 11, a vertical handlebar tube 12, a front tube 13, an upright tube 14, a front fork 16, and a front wheel 17, wherein one end of the vertical handlebar tube 12 is vertically connected with the handlebar 11, the other end of the vertical handlebar tube 12 is sleeved with the front tube 13, the other end of the front tube 13 is connected with the upright tube 14, the upright tube 14 is connected with the front fork 16 through a head set 15, and the front wheel 17 is fixed to the front fork 16;

The frame unit 2 comprises a connecting rod 22, a linking rod 21, and a stand 23, wherein the stand 23 comprises a footboard 231, a chassis 233, and two side cover plates 232 located on two sides of the footboard 231; the two sides of the footboard 231 are fixedly connected with the upper ends of the side cover plates 232, and the lower ends of two side cover plates 232 are fixedly connected with the chassis 233; the chassis 233 is located below the footboard 231, so that a space is reserved between the footboard 231 and the chassis 233; the linking rod 21 is located in the space between the footboard 231 and the chassis 233; one end of the connecting rod 22 is fixedly connected with a stand set 15, and the other end of the connecting rod 22 stretches into the middle of the footboard 231 from front to be fixedly connected with the front end of the linking rod 21; the rear end of the linking rod 21 is fixedly connected with the rear wheel unit 3; a protective plate 234 is correspondingly arranged at the position, where the connecting rod 22 stretches, of the footboard 231; the connecting rod 22 is pivoted to the protective plate 234; auxiliary wheels 24 are arranged under the two sides of the front end of the stand 23 and are slightly above the ground; and meanwhile, a slot 235 is formed in the rear end of the footboard 231, positioning plates 236 are arranged on two sides of the slot 235 and are provided with positioning holes 237, and a cushion connecting rod 45 is pivoted and connected to the positioning plates 236;

The rear wheel unit 3 comprises a pair of rotary shafts 31, a pair of swing arms 32, a pair of tie rods 34, and a pair of rear wheels 33, wherein the rotary shafts 31 are fixedly connected into the space between the footboard 231 and the chassis 233 and are connected with the front ends of the swing arms 32, the tail ends of the swing arms 32 are fixedly connected with the rear wheels 33 and are pivoted to the tie rods 34, and the other end of each tie rod 34 is pivoted and fixed to the linking rod 21;

The seat unit 4 comprises a cushion 41, a cushion base 43, and a cushion fixing rod 44, wherein the cushion base 43 is arranged under the cushion 41, the upper end of the cushion fixing rod 44 is pivoted to the cushion base 43, a curved bent part 441 is formed at the tail end of the cushion fixing rod 44 and stretches into the stand 23 to be pivoted to the tail end of the linking rod 21, a pivot part 442 is connected to the bent part 441 and is connected with the stand 23, and a seat back is arranged behind the cushion 41 and is provided with a handle 42; and in addition, the cushion fixing rod 44 is provided with a limiting plate 443 located in the bent part 441, and the limiting plate 443 is provided with a first limiting hole 444 and a second limiting hole 445.

The cushion fixing rod 44 and the cushion connecting rod 45 are stretched upwards to be straightened, and the pivot part 442 of the cushion fixing rod 44 is pivoted to the positioning plates 236, so that the cushion fixing rod 44 is able to swing with the pivot points of the positioning plates 236 as the fulcrum, the cushion connecting rod 45 also swings the pivot points of the positioning plates 236 e fulcrum, and in this way, the cushion fixing rod 44 and the cushion connecting rod 45 synchronously swing upwards to be positioned; afterwards, a pin 5 penetrates through the positioning holes 237 in the positioning plates 236 and the limiting holes in the limiting plate 443, so that the cushion fixing rod 44 and the cushion connecting rod 45 are fixed and kept upright and are prevented from being laid down accidentally, and the cushion 41 of the seat unit 4 is fixed to allow users to sit thereon.

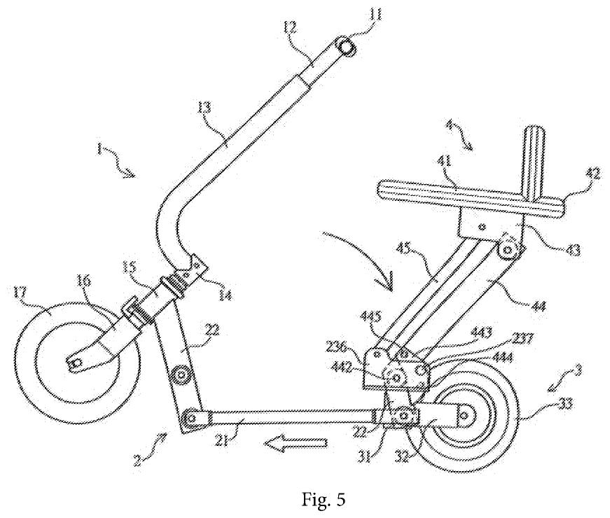

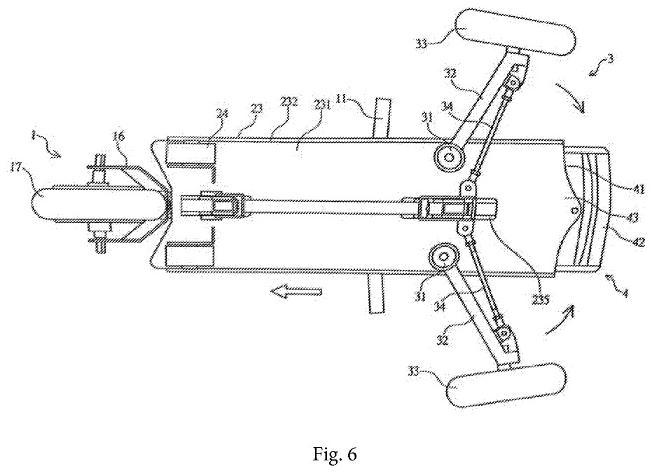

Referring to FIG. 5 and FIG. 6, when the scooter needs to be folded, the pin 5 is pulled out first, then the handlebar 11 is pressed downwards, and at this moment, the front wheel 17 is driven by the handlebar 11, the vertical handlebar tube 12, the front tube 13 and the head set 15 to tilt away from the ground; meanwhile, the connecting rod 22 pulls the linking rod 21 to move forwards; as the pin 5 has been removed in advance, the cushion fixing rod 44 pivoted to the tail end of the linking rod 21. is not limited by the pin anymore and is synchronously pulled to move when the linking rod 21 moves forwards; the curved bent part 441 is formed at the tail end of the cushion fixing rod 44, so that the cushion fixing rod 44 swings backwards with the pivot points between the pivot part 442 and the positioning plates 236 as the fulcrum; and when the cushion fixing rod 44 swings backwards, the cushion connecting rod 45 is driven to swing backwards synchronously, and thus, the cushion 41 is driven to move downwards.

When the connecting rod 22 pulls the linking rod 21 to move forwards, the linking rod 21 synchronously drives the tie rods 34 which in tum drag the swing arms 32 to retreat backwards with the rotary shafts as the fulcrum, so that the swing arms 32, the rear Wheels 33 and the tie rods 34 are folded behind the stand 23, and particularly, the swing arms 32 and the tie rods 34 are mostly drawn in the space between the footboard 231 and the chassis 233. In this way, the size of the scooter is minimized.

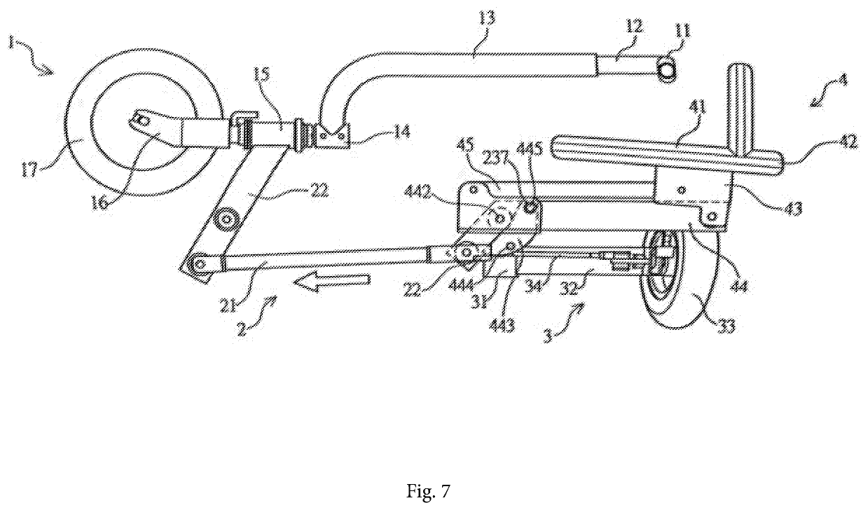

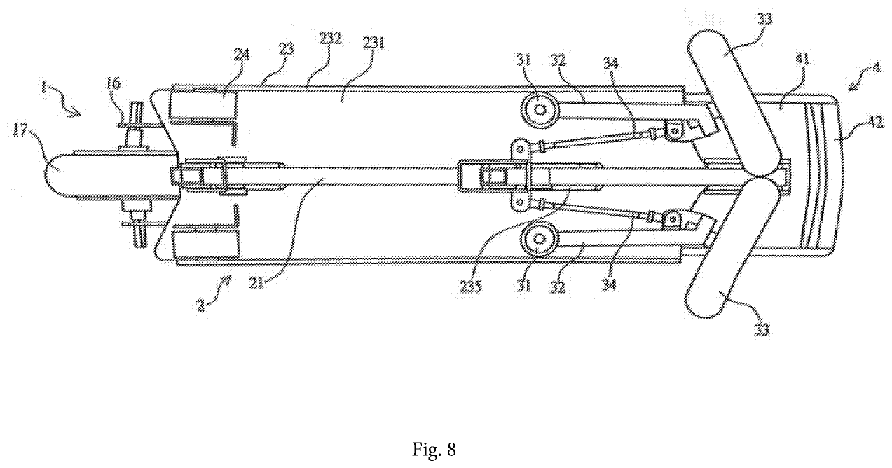

Referring to FIG. 7 and FIG. 8, when the size of the scooter is reduced by folding, the pin 5 is inserted into the positioning holes 237 of the positioning plates 236 again, and at this moment, the pin 5 penetrates through the positioning holes 237 to be inserted into the second limiting hole 445 in the limiting plate 443, so that the cushion fixing rod 44 is limited by the pin 5. and the cushion connecting rod 45 and the cushion 41 are fixed and cannot be moved at random; and on the other hand, the linking rod 21 is fixed and cannot drive the connecting rod 22 anymore, and the handlebar 11, the vertical handlebar tube 12. the front tube 13, the upright tube 14, the head set 15, the front fork 16 and the front wheel 17 are all fixed accordingly. In this way, the size of the scooter is minimized by folding, and the scooter can be folded easily and rapidly.

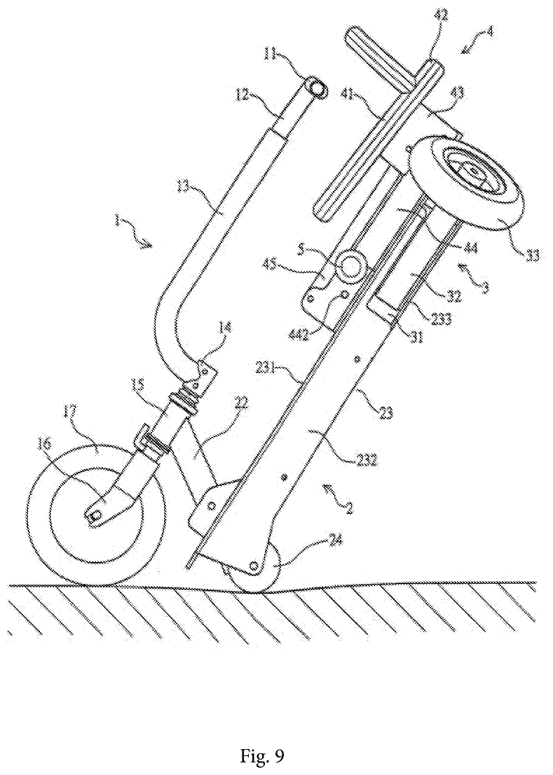

Referring to FIG. 9, users can lift the scooter by holding the handle 42 by hand, at this moment, the front wheel 17 tilting upwards descends to the ground, the auxiliary wheels 24 on the front portion of the stand 23 make contact with the ground, and then the users can pull the scooter to move more conveniently by holding the handle 42 on the seat back.

When the scooter needs to be used, the scooter is flatly placed on the ground, the pin 5 is pulled out, the handlebar 11 is pulled upwards, at this moment, the connecting rod 22 reversely pushes the linking rod 21 which in turn drives the cushion fixing rod 44 and the cushion 41 to rise, the inking rod 21 drives the tie rods 34 to synchronously push the swing arms 32, and then the swing arms 32 push out the rear wheels 33 in place with an axle 331 as the center; and afterwards, the pin 5 is inserted into the positioning holes 237 of the positioning plates 236 to penetrate through the limiting plate 443, and then the scooter in the folded state is rapidly unfolded.

This embodiment has the following beneficial effects: the linking rod 21 is pivoted to the connecting rod 22, and the cushion fixing rod 44 stretches into the slot 235 of the stand 23 to he pivoted to the tail end of the linking rod 21, so that when the handlebar 11 is pressed downwards, the front wheel 17 is driven to tilt away from the ground, and the connecting rod 22 pulls the linking rod 21 which in turn drives the cushion fixing rod 44 to swing backwards to drive the cushion 41 to descend; at this moment, the linking rod 21 synchronous pulls the tie rods 34 to drag the swing arms 32 to retreat backwards with the axle 331 as the fulcrum, so that the swing arms 32, the rear wheels 33 and the tie rods 34 are folded behind the stand 23, and the swing arms 32 and the tie rods 34 are mostly drawn into the space between the footboard 231 and the chassis 233 of the stand 23. In this way, the size of the scooter is minimized, and the scooter can he stored and transported easily.

The basic principle, main characteristics and advantages of the invention are illustrated and described above. Clearly, the invention is not limited to the details of the above exemplary embodiments, and those skilled in the art can implement the invention in other specific forms without deviating from the spirit or basic characteristics of the invention. Therefore, from any point of view, the embodiments in the above description should be regarded as nonrestrictive illustrative ones. The scope of the invention is defined by the appended claims instead of the above description, and all variations achieved based on the meanings and scopes of equivalents of the claims are included in the invention. Any reference sign in the Claims should not be regarded as limitations of the claims referred to.

In addition, it should be understood that although the invention is briefly described with reference to the embodiments, each embodiment does not include only one independent technical solution. Those skilled in the art should regard the specification as a whole, and the technical solutions in different embodiments can be properly combined to obtain other appreciable embodiments.

What is claimed is:

1. A foldable scooter, comprising a front wheel unit, a frame unit, a rear wheel unit, and a seat unit, wherein the frame unit comprises a connecting rod, a linking rod, and a stand; the stand comprises a footboard, a chassis, and two side cover plates located on two sides of the footboard; the linking rod is located in a space between the footboard. and the chassis; the connecting rod has an end fixedly connected with the front wheel unit and an end stretching into a middle of the footboard from front to be fixedly connected with a front end of the linking rod; a rear end of the linking rod is fixedly connected with the rear wheel unit; and the seat unit is located above the rear wheel unit and is connected with a rear portion of the stand.

2. The foldable scooter according to claim 1, wherein the front wheel unit comprises a handlebar, a vertical handlebar tube, a front tube, an upright tube, a front fork, and a front wheel, the vertical handlebar tube has an end vertically connected with the handlebar and an end sleeved with the front tube, the front tube has an end connected with the upright tube, the upright tube is connected with the front fork through a head set, and the front wheel is fixed to the front fork.

3. The foldable scooter according to claim 1, wherein the rear wheel unit comprises a pair of rotary shafts, a pair of swing arms, a pair of tie rods, and a pair of rear wheels, the rotary shafts are fixedly connected into the space between the footboard and the chassis and are connected with front ends of the swing arms, tail ends of the swing arms are fixedly connected with the rear wheels and are pivoted to the tie rods, and each said tie rod has an end pivoted and fixed to the linking rod.

4. The foldable scooter according to claim 1, wherein the seat unit comprises a cushion, a cushion base, and a cushion fixing rod, the cushion base is arranged under the cushion, the cushion fixing rod has an upper end pivoted to the cushion base and a tail end formed with a curved bent part, the bent part stretches into the stand to be pivoted to a tail end of the linking rod, and a pivot part is connected to the bent part and is connected with the stand.

5. The foldable scooter according to claim 1, wherein auxiliary wheels are arranged under two sides of a front end of the stand.

6. The foldable scooter according to claim 5, wherein the auxiliary wheels are slightly above the ground.

7. The foldable scooter according to claim 1, wherein a slot is formed in a rear end of the footboard, positioning plates are arranged on two sides of the slot and are provided with positioning holes, and the cushion connecting rod is pivoted and connected to the positioning plates.

8. The foldable scooter according to claim 1, wherein a seat back is arranged behind the cushion and is provided with a handle.

9. The foldable scooter according to claim 1, wherein the cushion fixing rod is provided with a limiting plate located in the curved part, and the limiting part is provided with a first limiting hole and a second limiting hole.

10. The foldable scooter according to claim 1, wherein a protective plate is correspondingly arranged at the position, where the connecting rod stretches, of the footboard, and the connecting rod is pivoted to the protective plate.
